(19) United States
(12) Patent Application Publication
(10) Pub. No.: US 2020/0223022 A1
(43) Pub. Date: Jul. 16, 2020

(54) WORK SUPPORT SYSTEM

(71) Applicant: Preddis LLC, Everett, WA (US)

(72) Inventors: Michael Worden, Everett, WA (US); Nathaniel Hallee, Minneapolis, MN (US)

(21) Appl. No.: 16/822,472

(22) Filed: Mar. 18, 2020

Related U.S. Application Data
(63) Continuation-in-part of application No. 15/933,632, filed on Mar. 23, 2018, now Pat. No. 10,633,154.

(51) Int. Cl. B23Q 1/26

(52) U.S. Cl. CPC B23Q 1/26

(57) ABSTRACT

A work stand includes upper and lower surfaces, the upper surface configured to support an object in a balanced manner above the work stand, and the lower surface configured to rest stably upon a work surface. Supports may be integrated into or attachable to the upper surface and may be selected to provide a predetermined support to the object, such support having an element of height and manner of contact with the object. Each support terminates in an apex which may be configured as a rounded, tapered, or flat configuration. The system may be utilized by placement upon a work surface and then placing an object upon an apex or ridge thereof, to support the object above the work surface.

### CROSS-REFERENCE TO RELATED APPLICATIONS

This application is a continuation-in-part of co-pending U.S. patent application Ser. No. 15/933,632, entitled “COMBINATION CAP AND WORK SUPPORT SYSTEM” filed Mar. 23, 2018, which is a continuation-in-part of co-pending U.S. patent application Ser. No. 14/269,536 entitled “COMBINATION CAP AND WORK SUPPORT SYSTEM” filed May 5, 2014, which is a continuation-in-part of co-pending U.S. patent application Ser. No. 14/268,056 entitled “COMBINATION CAP AND WORK SUPPORT SYSTEM” filed May 2, 2014, each of which is hereby incorporated by reference.

### BACKGROUND OF INVENTION

### Field of the Invention

The invention relates generally to an improved multi-functional work stand.

### Background Art

Surface coatings such as paints, varnishes, sealants, and lubricants are commonly applied to objects via spray, brush or roller devices. Often, such coatings require significant drying times, and it is generally desirable to minimize contamination of a work surface or surrounding objects by unintended contact with such coatings. Wet surface coatings may also cause unintended and undesirable adhesion of an object to a work surface or other items, which may damage the work surface, the object, and/or the coating.

Additionally, access to all of the various surfaces of the object, during application of the surface coating, may pose a challenge. For example if an object to be coated is placed on a flat work surface, the lower edges and bottom side(s) of the object may be relatively inaccessible for application. In practice, this often means that such coatings must be applied in two phases, with the second occurring only after the first surfaces have dried and the object can be rotated for application to the other surfaces. This is generally an inefficient practice.

Tabletop support stand systems have been developed to support an object during application of a surface coating. Generally, it is desirable that such systems provide a high degree of stability, with a minimal degree of contact with the object surface, so as not to interfere with the application process, as well as to permit shortened drying times via air circulation around the drying surfaces.

One such system is the Painter's Pyramid® by K&M of VA, Inc. As shown in prior art FIG. 1A, such pyramidal designs have a single apex configuration with triangular sides. Certain configurations of the pyramidal stands are also configured to interlock in a manner that allows them to support non-planar objects such as rods or spheres between multiple pyramids. Other prior art approaches include the cone-like devices of, e.g., U.S. Design Pat. Nos. D642447, D668,933, and D672,222 by Bucci shown in FIG. 1B, and the cubic and spherical configurations disclosed in U.S. Pat. No. 8,347,811, also by Bucci.

Another example of a small work surface stand is the Bench Cookie® and attachable cones and bridges by Rockier®. As shown in prior art FIGS. 2A-2B these comprise a system of circular stackable pucks, used with a cone clip and/or bridge clip that provides a contact point for an object to be supported. The pucks and clip-on elements may be utilized in multiple configurations to provide similar functionality to that of the pyramid devices.

The prior art work stand devices described herein typically require that the supported object generally have a contact surface that is significantly greater than the diameter of the stand, as the object must span multiple stands since such stands are not individually configured to support an object. Accordingly, there exists a need for an inexpensive work stand capable of individually supporting a variety of objects and providing an increased stability, whether used alone or in multiples, and capable of supporting an object with minimal contact.

### SUMMARY

In one aspect, the invention relates to a work support system that is configured at a lower end to rest upon a work surface, and at an upper end to provide a predetermined support system for supporting objects during application of a surface coating or other project.

The work support system may be configured to be reversibly fastened to a work surface, and to support various types, configurations, quantities, and masses of objects. It will generally be configured with a plurality of supports, ridges and apices, for providing a desired contact surface with an object.

The work support system may be configured with multiple configurations of supports on different sides.

The work support system may be packaged as a component of a kit, in conjunction with a can, one or more weighted and/or rotating bases, and one or more combination cap and work support components.

The work support system may be manufactured in a single or multi-shot mold, as well as in a multi-cavity mold to produce multiple products simultaneously. Multiple materials may be used in each mold.

Other aspects and advantages will be apparent from the following description and the appended claims.

### BRIEF DESCRIPTION OF DRAWINGS

FIGS. 1A-1B show a prior art pyramid-style stand.

FIGS. 2A-2B show a prior art puck-style stand.

FIGS. 3A-3C show an embodiment of a work stand having various configurations of supports.

FIG. 4A-4C show an embodiment of a work stand, with various cross-sectional supports.

FIGS. 5A-5C show an embodiment of a work stand, with various configurations of sidewall openings.

FIGS. 6A-6C show embodiments of a work stand, having different shapes.

FIGS. 7A-7B show embodiments of a work stand, with a cavity and channel.

FIGS. 8A-8C show embodiments of an work stand, in use with dowels and fasteners.

FIGS. 9A-9C show embodiments of a work stand, with various sidewall surface configurations.

FIGS. 10A-10C show embodiments of a work stand, with alternative configurations of cavities.

FIGS. 11A-11C show embodiments of a work stand having various configurations of ridges and valleys.

FIG. 12 shows an alternative embodiment of a work stand having an open configuration.

FIG. 13 shows an embodiment of a work stand with peripheral opposed ridges separated by a valley.

FIG. 14 shows an embodiment of a work stand with a plurality of integrated supports separated by intersecting valleys.

FIG. 15 shows an embodiment of a work stand having three integrated supports on a first side, and four integrated supports on a second side.

FIG. 16 shows an embodiment of a work stand having varying quantities of cavity on differing sides.

FIG. 17 shows an embodiment of a work stand in a stacking configuration.

FIG. 18 shows an embodiment of a work stand with an integrated drip ledge.

FIG. 19 shows an embodiment of a work stand with asymmetrically distributed ridges.

FIG. 20 shows an embodiment of a work stand having elastomeric elements, with ridges disposed both centrally and peripherally, separated by valleys.

FIG. 21 shows an embodiment of a work stand configured to operatively connect a separate base.

FIG. 22 shows an embodiment of a work stand having a plurality of integrated supports and a vertical passage formed in an sidewall surface.

FIG. 23 shows an embodiment of a work stand with a separable support configured to operatively connect to a plurality of cavities.

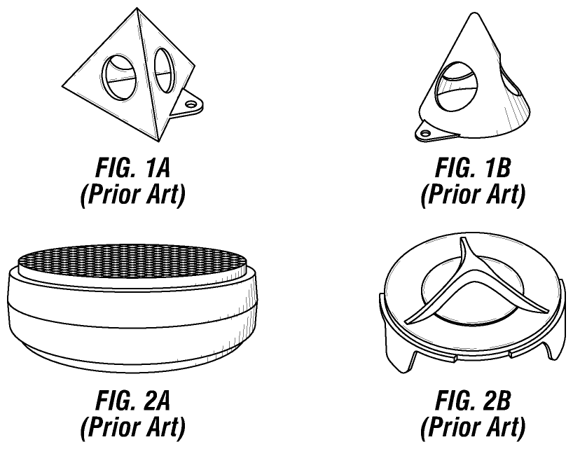

### DETAILED DESCRIPTION

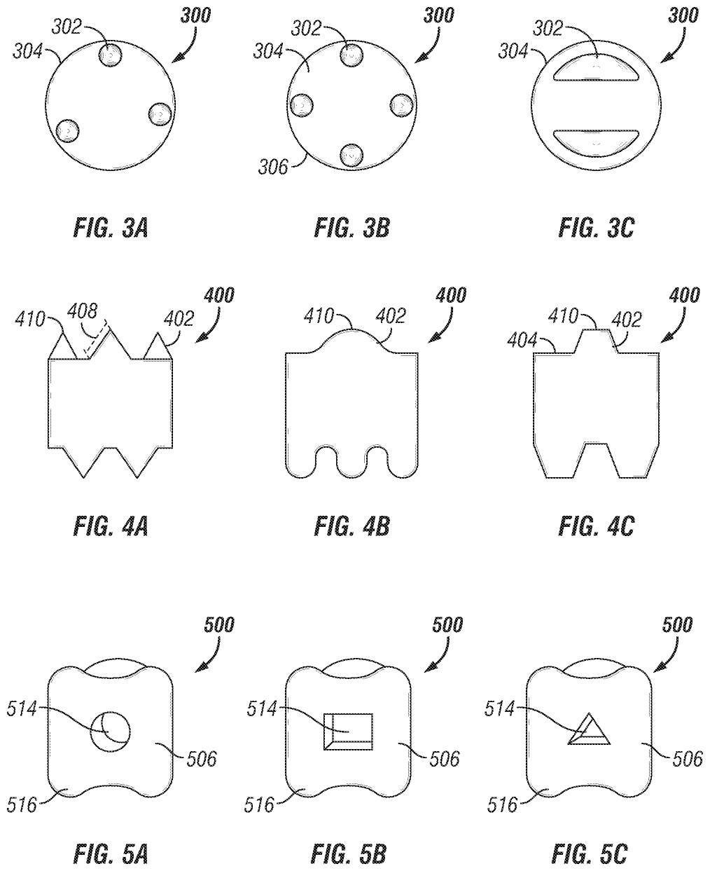

As shown in FIGS. 3A-3C, embodiments of a work stand 300 may include various configurations of supports 302 on a support surface 304 thereof. Such supports 302 may have a generally circular cross section (FIGS. 3A-3B), a semi-circular cross section (FIG. 3C) or various other cross-sectional configurations such as a triangular/wedge configuration, etc.

In various embodiments, supports 302 may vary in width and cross-section as they extend away from the support surface 304. In various embodiments, the supports 302 may also be configured to mate with similar or dissimilar supports on a second work stand 300, such that a plurality of such work stands 300 may be securely stacked to achieve a desired height.

In various embodiments, supports 302 are generally spaced substantially equidistantly upon the support surface 304 to provide for an improved balance to a supported object. In one embodiment, the supports 302 will typically be disposed along or near a periphery of the support surface 304. One or more central supports 302 may also be included along with peripheral supports 302.

As will be later shown and described, supports 302 may be molded in place or may be operatively connected via e.g., a reversible mating connection with the work stand body 306. The former advantageously provides a more cost-effective manufacturing option and more stable work stand configuration, while the latter advantageously provides a user-customizable work stand configuration to balance a variety of object shapes and sizes, and is capable of more compact storage.

As shown in FIGS. 4A-4C, supports 402 will generally include a taper 408, terminating in an apex 410 (plural “apices”) that may have a relatively sharp (FIG. 4A), rounded (FIG. 4B) or relatively flat (FIG. 4C) configuration. Sharper apices will advantageously provide a minimized contact area with a supported object for e.g., access to a less obstructed surface thereof for application of surface coatings, or more effective drying thereof.

Flat apices will advantageously provide a greater contact with a supported object for a more stable support configuration. A greater surface area in contact with an object generally helps to balance the object on the work stand 400. Rounded apices will advantageously provide a compromise between flat and pointed apices having a generally reduced contact area while providing a desired stability to a supported object.

In one embodiment, supports 402 may be interchangeable such that an end user can easily replace one configuration with another depending on the desired application. Any method of operatively connecting the support 402 to the support surface 404 may be utilized. Generally the number and configuration of supports 402 will be selected to reliably balance an object above the work stand 400 while minimizing contact surface to provide for sufficient access for assembly or application of a surface coating as well as maximal airflow for the drying thereof.

As will be later shown and described, in one embodiment, the support surface 404 will include a number of cavities at predetermined locations for the insertion of a base portion of a support 402, advantageously providing a customizable configuration. Such a configuration also advantageously provides the capability to remove all supports 402 to provide for efficient storage of the work stand bodies in a stacked configuration.

As shown in FIGS. 5A-5C, embodiments of the work stands 500 may include sidewall openings 514 disposed in a sidewall 516. Such openings 514 may traverse the entire body 506, or may only partially penetrate the body 506 of the work stand 500. Sidewall openings 514 may be of various sizes and configurations, although they will preferably scale with work stand size.

One advantage of the sidewall openings 514 is the capability to link multiple stands 500 atop a work surface in a desired configuration by using extension rods to link multiple stands 500. To this end, sidewall openings 514 may be provided at different compass points along the sidewall 516 of the work stand 500, to permit various layouts when multiple work stands are linked.

Extension rods may be specially configured, or may include common longitudinal items found in a work environment such as dowels, and other lumber, pipe, etc. The shape of the sidewall openings 514 may be selected to provide additional advantages such as stabilizing the work stand 500 on the work platform when an extension rod is disposed therein.

In one embodiment, sidewall openings 514 will be disposed at differing heights for differing spacings. For example 90-degree compass spacing of a first set of sidewall openings 514 at a first height, and 120-degree compass spacing of a second set of sidewall openings 514 at a second height. Such configurations advantageously provide the capability to link multiple work stands 500 in various spaced configurations upon a work surface.

The use of extension rods and the like to operatively connect multiple work stands 500 in a desired configuration via the sidewall openings 514, advantageously provides the capability to support objects far larger than the work stands 500 and to also create, e.g., a framework for supporting objects placed upon the extension rods themselves. Such flexibility may be particularly useful for drying applications where it may be desirable to support an object above a drop cloth or disposable material during the drying (or application) of a surface coating, without contaminating the work stand 500.

Extensions rods disposed at a uniform height between work stands will advantageously provide a stable and balanced platform for the placement of objects. Alternatively extension rods disposed at varying heights between work stands may advantageously provide a desired degree of tilt to an object placed thereupon for the increased drainage of excess surface coatings, etc. Additionally, drop cloths and the like may be disposed on the work surface beneath the extension rods to protect the work surface from waste products and overspray.

Additionally, sidewall openings 514 may form a passage through the body 506 of the work stands 500 that may be utilized to raise and move multiple work stands as a set, to maintain a desired support of an object placed thereupon during transport, or to relocate a desired configuration of work stands without the need for disassembly and reassembly.

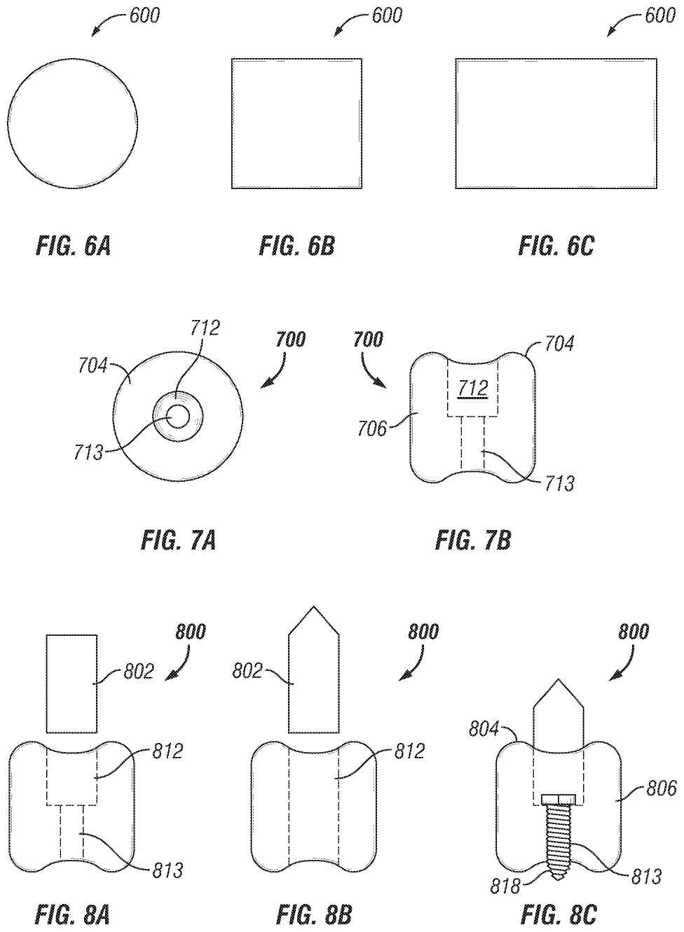

As shown in FIGS. 6A-6C, embodiments of the work stand 600 may have different configurations, such as, but not limited to, circular (FIG. 6A), square (FIG. 6B), and rectangular (FIG. 6C) cross-sections. Configurations may be advantageously selected to correspond to a predetermined object to be supported by the work stand 600.

Additionally, in combination with interchangeable supports, works stands may be configured with multiple sets of supports per stand, each set selected to support a predetermined object, thus advantageously providing for support of multiple objects per work stand. Such configurations may be particularly advantageous when using the work stands to support objects that will be fastened together in a particular configuration via adhesives and the like, or to apply surface coatings uniformly upon multiple objects supported by the work stand(s).

Interchangeable supports may be packaged as a kit, along with or separate from a work stand body. Various kits may be configured to balance and support predetermined object configurations. For example, for spherical objects, supports having rounded or curved apices may be desirable and for planar objects, a kit of supports having flat or planar apices may be desirable.

As shown in FIGS. 7A-7B, cavities 712 in the support surface 704 of the work stand 700 may be configured to accommodate a support, a fastener (for fastening the work stand to a work platform), or a combination of both. While a cavity 712 for a support need not penetrate entirely through the body 706, such a configuration advantageously provides for the option to place a fastener within the cavity 712, beneath the space for a support 702. As shown in FIG. 7B, a passage 713 for a fastener may have a smaller diameter than an operatively connected cavity 712 to ensure that the penetration of a support is limited, while still permitting passage of a fastener through the entire body 706 of the work stand 700.

In two-sided configurations having cavities 712 at similar locations on both an upper support surface and a lower support surface, the upper and lower cavities may be connected via the passage 713 to permit the passage of a fastener through both opposing cavities 712 while retaining the head of such a fastener within the upper cavity 712. The passage 713 need not match the cavity 712 in cross-sectional configuration, and will preferably be circular.

Cavities 712 may have a circular cross section, to advantageously permit the rotation of a support that is secured therein. This is particularly useful for asymmetric supports that may be rotated to form a desired supporting configuration such as a cradle between two supports.

Alternatively, cavities 712 may have elliptical, square, rectangular or other configurations to advantageously secure a support in a predetermined orientation. Such may be advantageous when it is desired to maintain an asymmetric support in a predetermined orientation.

Embodiments of the work stand 700 may include flat or ridged support surfaces 704 having cavities 712 disposed therein and configured to utilize common dimensions of common objects such as dowels, golf tees, etc. as supports. Such configurations advantageously permit user customization of the work stand 700 to adjust for object support at differing heights and with differing configurations of objects.

As shown in FIGS. 8A-8C dowels and similar objects may be utilized as supports 802 when operatively connected to cavities 812 disposed in the support surface 804 of the work stand 800. As previously described, such cavities 812 may pass completely through the body 806, may be configured to have multiple diameters at various depths, and may include a channel 813 to permit the use of fasteners 818 while advantageously limiting penetration of the supports 802 into the work stand body 806.

In one embodiment different sizes or configurations of cavities 812 may be disposed in opposite (i.e., top and bottom) support surfaces 804 of the work stand 800 to permit use with different diameters of supports 802 depending on the side in use. The cavities 812 may be connected by a channel 813 disposed within the center of the work stand body 806, to permit the placement of fasteners from either side, while still limiting the penetration of the support 802.

Placement of cavities 812 in both top and bottom support surfaces 804 of the work stand 800 permits use of supports 802 on both sides at the same time, advantageously providing the capability to use a first set of supports 802 as legs to support the work stand 800 above a work surface and also customize the supportive configuration of the work stand 800 to support an object.

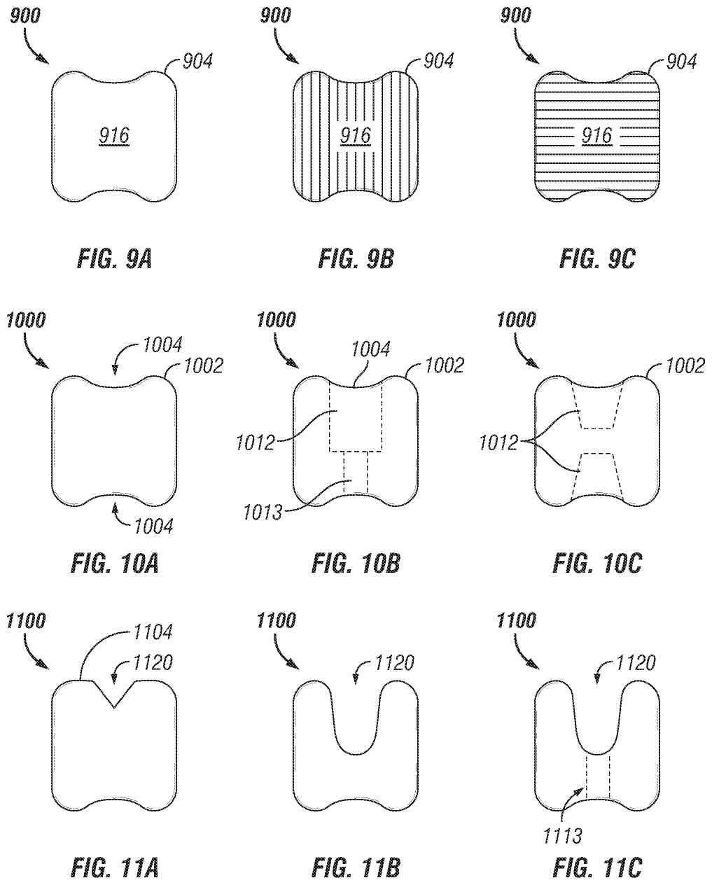

As shown in side view, the embodiments of FIGS. 9A-9C comprise a sidewall 916 that may have a smooth or textured surfaces, or combinations thereof. Smooth surfaces advantageously provide for easier cleaning of the work stands 900 and facilitate the placement of logos, labels (e.g., size, etc.) and the like. Vertical ridges provide for a better grip of the work stands and increased drainage of e.g., excess surface coatings or lubricants applied to an object placed thereupon. Horizontal ridges advantageously provide for an even more secure grip. Combinations of horizontal ridges, vertical ridges, and smooth surfaces may be utilized on a single work stand 900 depending on various design factors.

As shown in the embodiments of FIGS. 10A-10C, embodiments of the work stand 1000 may be configured with molded supports 1002 in the form of ridges, and an otherwise solid form, with a single cavity 1012 for a support 1002 which may include a channel 1013 for fastening to a work surface. Cavities 1012 for supports 1002 may be disposed in both a top and bottom support surface 1004, or in any combination thereof.

As shown in the embodiments of FIGS. 11A-11C, embodiments of the work stand 1100 may be configured with raised ridges separated by a valley 1120. The valley 1120 may be disposed in a central location of the work stand support surface 1104, and may have various configurations. In one embodiment, the valley 1120 may include at least one channel 1113 disposed in a lower portion thereof for e.g., the passage of fasteners or the drainage of fluids. Valley(s) 1120 may be bounded by ridges for supporting an object or may themselves cradle an object placed across the surface of the work support, or nested within the valley itself (such as a leg of a table).

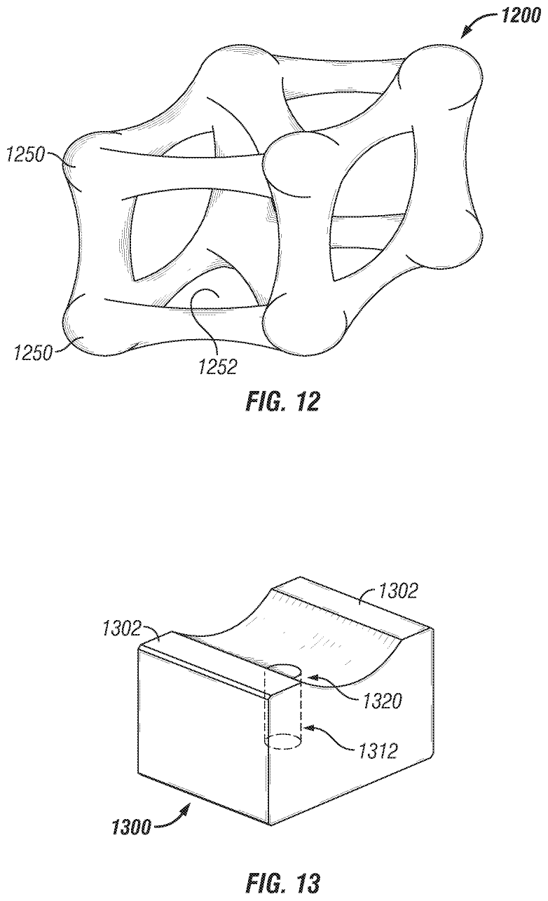

FIG. 12 shows an alternative embodiment of a work stand 1200 having an open structure comprised of interconnected nodes 1250. Gaps 1252 between nodes 1250 may advantageously facilitate drainage through the work stand 1200, or may be utilized for placement of supports. Such a configuration advantageously provides a lightweight versatile work stand 1200 with improved drainage characteristics.

As shown in the embodiment of FIG. 13, a work stand 1300 may comprise integrated supports 1302 in the form of peripheral opposed ridges separated by a valley 1320. A cavity 1312 or channel may be formed in a lower area of the valley 1320.

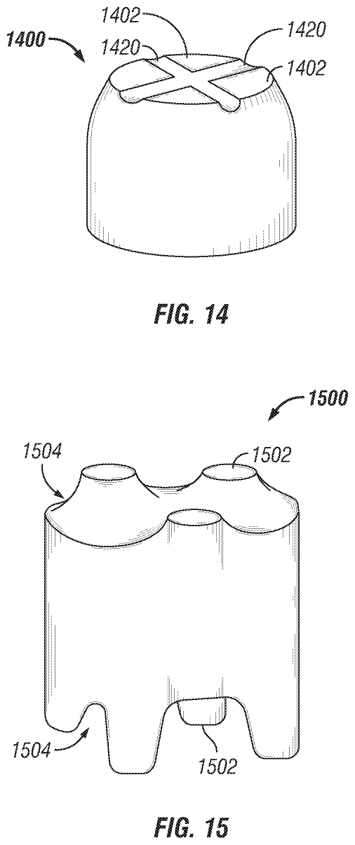

As shown in the embodiment of FIG. 14, a work stand 1400 may comprise a plurality of intersecting valleys 1420 separating a plurality of molded supports 1402. Patterns of valleys 1420 and supports 1402 may vary between an upper support surface 1404 and a lower support surface, such that the work stand 1400 may be inverted to provide an alternative support configuration. In one embodiment, the work stand body may be configured with multiple sides each of which includes a different orientation of valleys and supports, to advantageously provide an increased variety of alternative support configurations to the end user.

As shown in the embodiment of FIG. 15, the quantity of integrated supports 1502 may vary between a top and a bottom support surface 1504. In this embodiment, the top support surface includes three supports 1502 and the bottom support surface includes four supports 1502. Thus the work stand 1500 may be inverted to alternate between the different support configurations. Such a configuration can advantageously be formed as a single piece at a lower cost and increased structural integrity while also providing multiple support configurations.

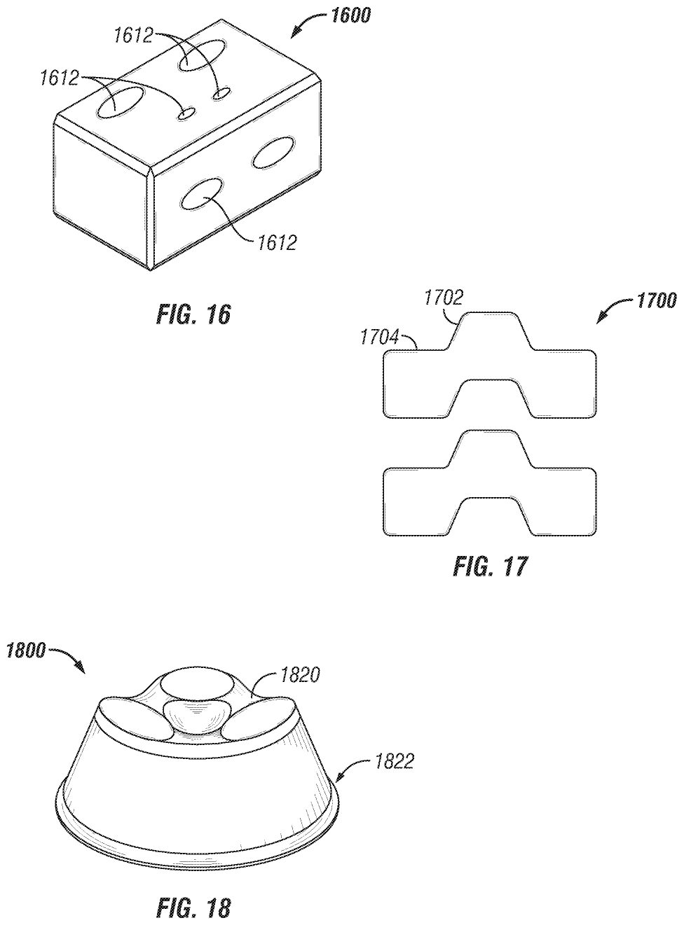

As shown in the embodiment of FIG. 16, the quantity, configuration and location of cavities 1612 may vary from surface to surface of the work stand 1600 to advantageously provide increased versatility in configuring the work stand 1600 for a particular load. In one embodiment, one or more surfaces may include integrated supports, and other surfaces of the same work stand 1600 may include cavities for removable supports.

In one embodiment, a plurality of sides, and possibly all sides, may be configured with a different combination and/or configuration of integrated supports and/or cavities. Such a configuration would advantageously provide numerous options for supporting various shapes and sizes of objects in a balanced manner by simply rotating the stand body to position the desired supports in a desired configuration. Similarly, interchangeable supports may comprise any size, shape and composition to provide an increased flexibility in configuring the work stand. Typically, however, it may be advantageous to ensure that the base portions of the interchangeable supports have sufficient commonality to operatively connect to predetermined cavity configurations.

As shown in the embodiments of FIG. 17, work stands 1700 may be configured with form a secure stacking relationship of multiple work stands for storage, or to achieve a desired height. Ridges and similarly integrated supports 1702 on a support surface 1704 may form a mating relationship with an opposing support surface to more securely nest in a desired configuration. Additionally, removable supports may be operatively connected between opposing surfaces to support a first work stand at a desired height above a second work stand.

As shown in the embodiment of FIG. 18, a drip ledge 1822 may be disposed along the lower periphery of a work stand 1800 to capture excess fluids. These may be disposed along the entire periphery, or may be located or enlarged at areas beneath valleys 1820 where runoff is more likely to occur.

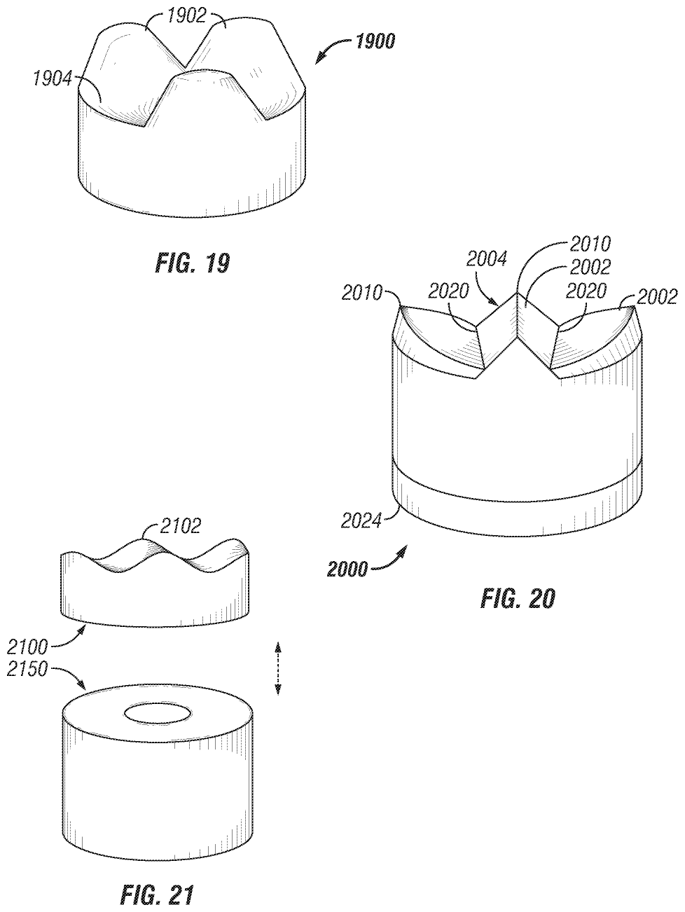

As shown in the embodiment of FIG. 19, integrated supports such as ridges 1902 may be disposed asymmetrically on a support surface 1904 of a work stand 1900.

As shown in the embodiment of FIG. 20, integrated supports such as ridges 2002 may be disposed in both peripheral and central locations on the support surface 2004 of a work stand 2000, separated by valleys 2020. Apices 2010, as well as the base portion 2024, may comprise an elastomeric material to advantageously stabilize the work stand 2000 on a work surface and/or prevent marring of, or more stably support, an object placed thereupon.

Additionally, as shown in the embodiment of FIG. 21, the work stand 2100 may comprise an elastomeric or similar pliable material configured to operatively connect to a separate rigid base 2150. Advantages of such configurations include the capability to have multiple configurations of work stands that may be more expensive to produce, capable of combining with various inexpensive rigid base portions to provide a desired elevation. Additionally, such configurations may utilize aerosol can caps and the like as a rigid base, and will thus be configured to operatively connect to such items.

Similarly, when utilized with expensive base elements such as those formed of more expensive materials, containing fillers or additional elements, embodiments of the work stand advantageously provide a less expensive alternative than the purchase of numerous bases having desired configurations by allowing the use of a single base with multiple configurations of work stands to provide multiple configurations of support options.

Embodiments configured to be utilized with separate bases may be configured to connect to such bases in any manner known in the art. This may include stretching over a portion of the base to form a secure frictional mating relationship, threading or similar fastening configurations, the use of separate fasteners to connect to the base, adhesion, and the like.

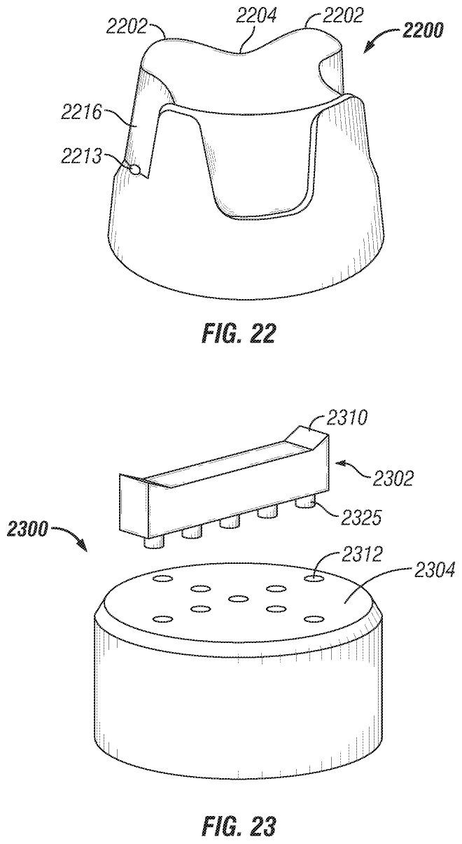

As shown in the embodiment of FIG. 22, the work stand 2200 may include a passage 2213 for a fastener proximal the sidewall 2216 thereof. This passage 2213 may be accessible at a location that is lower than the support surface 2204, advantageously providing the ability to pass a fastener (not shown in FIG. 22) through the passage 2213 to secure the work stand 2200 to a work surface, even when the support surface 2204 may be obstructed by an object placed thereupon.

As shown in the embodiment of FIG. 23, a single support 2302 may be configured to operatively connect to a plurality of cavities 2312 disposed in the support surface 2304 of the work stand 2300. Cavities 2312 may be disposed in any desired configuration in the support surface 2304 and in one embodiment may be included in the majority of the support surface 2304. Protrusions 2325 in the base section of the support 2302 will reversibly mate with the cavities 2312.

The combination of multiple cavities 2312 with various configurations of supports 2302 advantageously provides a high degree of modularity and customization to the work stand 2300 to provide an end user with the ability to support a wide range of objects with a desired degree of contact.

Embodiments of the work stand may comprise any material or combinations thereof known in the art. These may typically include, but are not limited to, wood, various plastics, metals, and elastomers. In one embodiment, the work stand may be formed of plastic in combination with an elastomeric material disposed at a lower end to advantageously provide a greater stability to the work stand, as well as some shock-absorbing characteristics. Such multi-material configurations may be manufactured via dual-shot/multi-shot molds. Additionally, multi-cavity molds may be utilized to produce multiple work stands in parallel, thereby increasing volume of production and decreasing production times.

Other elastomeric surfaces may be added to various locations of the work stand, including the apices, to e.g., increase stability, decrease slippage of a supported object, and improve gripping surfaces for a user. Wall thickness of an work stand, or various components thereof, may vary and may be selected based upon a desired durability, cost, use, and/or capacity. Embodiments of the work stand, particularly those configured to nest, may be manufactured without any negative draft angles to advantageously facilitate removal from the mold.

Embodiments of the work stand may also be constructed of multiple, separately formed components. For example, a plastic body may be operatively connected to an elastomeric base and/or elastomeric elements may be operatively connected to apices at predetermined locations on the plastic body. In one embodiment, holes or slots may be formed in the apices, to operatively connect tips configured to have a desired contact characteristic with an object. For example the tips may be elastomeric, pointed, round, textured, and/or replaceable or interchangeable. Alternatively, nails, rods, or other elongated objects may be positioned in holes disposed in the apices, to facilitate a minimal contact area and increased accessibility to a supported object.

In one embodiment, an outer surface of the work stand will be configured to reversibly connect to an inner surface of a second work stand, to advantageously provide a reversible locking configuration of multiple work stands, permitting a stack of work stands to be used and moved as a unit. This can be accomplished by utilizing connection elements configured to also connect to a can, or by means of an independent set of connection elements. Such connection elements may be frictional, threaded, or of any other type known in the art. In one embodiment, segments of the work stand may be individually configured to nest at least partially within other segments, in a stable manner.

In one embodiment, an upper section of the work stand may be configured to operatively connect to a lower section of a can, thereby advantageously permitting cans to be stacked upon one another, in a stable manner. Embodiments of the work stand may be included in place of, or in addition to, traditional caps/lids. For example, an work stand may be configured to seal a container, or may be operatively connected to a container having an existing cap/lid that provides a seal. In one embodiment, a lid of a container may be configured to operatively connect to an work stand, advantageously providing a base for the work stand.

While the work stand may be configured with any number of ridges and apices, 3-5 such support elements may advantageously provide a desired combination of single-unit functionality in combination with minimal contact surfaces (reduced obstruction). It may also be advantageous to ensure that all work stands from a particular source have similar or identical characteristics, to ensure interoperability, including uniform height of apices and/or ridge configurations, and inter-connectible connection elements.

While the work stand may have any dimensions suited for its intended use, a configuration wherein the height of the work stand is substantially less than its width may advantageously provide an increased stability for the work stand's supportive functions. In one embodiment, such a substantially greater width shall mean that the width is at least twice the height, as measured at the widest and highest points, respectively. In one embodiment, such width will be at least three times the height.

In one embodiment, the work stand may comprise one or more cavities disposed on a lower side thereof, such that they are substantially enclosed between an work stand and an operatively connected can or work surface. Such cavities may be configured to contain sponges or other devices for applying a surface coating, and may be circular, or configured to maximize the useable space under one or more segments of an work stand. Such cavities may include supportive sidewalls for providing structural rigidity to the work stand when connected to a can or work surface.

As used herein, the term “apex” (plural “apices”) shall mean a high point relative to surrounding structure. While the highest point(s) of a work stand will generally be apices, additional apices may be formed at a secondary height, so long as they are the highest points relative to immediately surrounding structure. For example, a first ridge may terminate at a first pair of apices at either end, while a second ridge may terminate at a second pair of apices at either end, and the first and second pairs of apices may have differing heights. Other meanings of the term within the spirit of the invention may also apply.

As used herein, the term “radial” as applied to a ridge, has a preferred meaning of extending along at least a portion of an imaginary line extending from the center of the work stand toward a point on the periphery of the work stand. A radial ridge may have a length greater than that of the radius of the work stand. An “extended radial ridge” as used herein means that such a ridge is disposed such that it extends from a first half of the work stand, across the center and into a second half of the work stand. As used herein, the term “peripheral” as applied to a ridge, has a preferred meaning of being generally aligned in a direction that corresponds to an peripheral border of the work stand. Any combination of radial and/or peripheral ridges may be utilized with various embodiment of the work stand.

As used herein, the term “substantially equidistant” has a preferred meaning of having less than 20% variation in distance, and more preferably less than 10% variation in distance. The terms “lower section” and “upper section” are terms of convenience utilized herein to identify functional regions of the work stand. Generally, the lower section will include elements for connecting and/or resting upon a work surface, while the upper section will include elements for supporting an object.

As used herein, the term “central region” as applied to the work stand, has a preferred meaning of within an area bordered on its outer periphery by an imaginary line bisecting the radius of the work stand. As used herein, the term “peripheral region” as applied to the work stand, has a preferred meaning of outside an area bordered on its inner periphery by an imaginary line bisecting the radius of the work stand. The terms “proximal” and “distal,” respectively, may be used to generally identify areas within such regions, and relative to the center of the work stand, with “proximal” being nearer the center, and “distal” being further from the center. Other meanings of these terms which do not conflict with the spirit of the invention may also apply.

The terms “circumference,” “diameter,” “radius,” and variations thereof, as used in this application, may encompass non-circular applications corresponding to the concepts of a perimeter, or length, of non-circular elements, when such is clearly indicated by accompanying descriptive language. The scope of these terms may be further defined by exemplary reference elements in the drawings.

The terms “comprising,” “including,” and “having,” as used in the claims and specification herein, indicate an open group that includes other elements or features not specified. The terms “a,” “an” and the singular forms of words include the plural form of the same words, and the terms mean that one or more of something is provided. The terms “at least one” and “one or more” are used interchangeably.

The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of an embodiment.

As used herein, the terms “cavity” and “chamber” are synonymous and used to describe a hollow space, typically open or openable on at least one end or side.

Many novel features disclosed herein may be utilized with caps and lids for containers such as spray cans. While generally disclosed as having a circular base, embodiments of the invention may include a square base or any other shape known in the art. Work stands may have an overall cylindrical, oval, rectangular, square or other shape, (generally selected to conform to a predetermined configuration of an object to be supported, or type of tasks to be performed) and such may vary among different sections of an work stand. Embodiments of the work stand may also include an upper section that is hingeably connected to a lower section to permit access to an interior space.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A work stand, comprising:
a plurality of supports selected from integrated supports and interchangeable supports, the selected supports configured to balance a predetermined object above the work stand;
a body configured to rest horizontally on a planar work surface, the body comprising first and second opposing surfaces;
the first surface comprising at least one selected from integrated supports and cavities;
the second surface comprising at least one selected from integrated supports and cavities; and
wherein the selected supports each comprise an apex configured to operatively connect to the predetermined object.

2. The work stand of claim 1, wherein the first surface comprises a plurality of ridges.

3. The work stand of claim 2, wherein the second surface comprises a plurality of ridges.

4. The work stand of claim 2, wherein a distribution of the plurality of ridges is asymmetrical.

5. The work stand of claim 1, wherein the second surface comprises a plurality of raised ridges, the raised ridges having a substantially uniform height and configuration.

6. The work stand of claim 1, wherein the supports comprise an integrated ridge.

7. The work stand of claim 1, wherein at least one of the interchangeable supports is configured to operatively connect to a plurality of cavities.

8. The work stand of claim 1, further comprising a sidewall disposed at a peripheral surface of the body and having a surface texture selected from horizontally-ridged, vertically-ridged, and smooth.

9. The work stand of claim 8, further comprising at least one sidewall opening in the sidewall of the body.

10. The work stand of claim 1, wherein at least one of the cavities is operatively connected to a passage having a smaller diameter than the cavity.

11. The work stand of claim 10, further comprising a fastener disposed substantially within the passage.

12. The work stand of claim 1, wherein a first cavity disposed in the first surface is operatively connected to a second cavity disposed in the second surface, by a passage therebetween, the passage having a smaller diameter than the diameters of each of the first cavity and the second cavity.

13. The work stand of claim 1, wherein the first side of the body comprises a first plurality of integrated supports and the second side of the body comprises a second plurality of integrated supports, and the first plurality of integrated supports differs from the second plurality of integrated supports in at least one chosen from quantity and configuration.

14. The work stand of claim 1, wherein a separation between each of the at least one selected from integrated supports and cavities disposed on a first surface is substantially identical.

15. The work stand of claim 1, wherein each of the supports includes a tapered cross section and a tip configuration selected from pointed, flat, and rounded.

16. The work stand of claim 1, wherein the cavities comprise a non-circular cross-section to inhibit rotation of an operatively-connected support.

17. The work stand of claim 1, wherein the distribution of cavities on at least one selected from the first surface and the second surface, comprises at least one selected from a radial distribution and a peripheral distribution.

18. The work stand of claim 1, wherein the second surface is configured to operatively connect a separate weighted base.

19. The works stand of claim 1, wherein at least one selected from a ridge, an apex of at least one of the plurality of supports, and a base portion of the body, comprises an elastomer.

20. A work stand kit, comprising:
a work stand body comprising:
an upper surface and a lower surface; and
a plurality of cavities disposed in at least one selected from the upper surface and lower surface; and
a plurality of supports having a substantially similar configuration, each of which comprises a base portion configured to reversibly connect to at least one selected from the plurality of cavities disposed in the work stand body.
